(19) United States
(12) Patent Application Publication
(10) Pub. No.: US 2005/0165748 A1
(43) Pub. Date: Jul. 28, 2005

(54) Method and apparatus for querying a computerized database

(75) Inventors: KahHing Ting, Singapore (SG); YingLeong Neo, Singapore (SG); HwaLiang Ng, Singapore (SG); LipHong Teo, Singapore (SG); ChinSoon Yoap, Singapore (SG); ChaiHian Gaw, Singapore (SG)

Correspondence Address: Seagate Technology LLC;Intellectual Property, OKM178, 10321 West Reno, Oklahoma City, OK, 73127-7140, US

(73) Assignee: Seagate Technology LLC, Scotts Valley, CA (US)

(21) Appl. No.: 10/758,643

(22) Filed: Jan. 15, 2004

(51) Int. Cl. G06F 7/00

(52) U.S. Cl. 707/3

(57) ABSTRACT

Method and apparatus for querying a computerized database, such as a distributed database associated with an automated manufacturing process and linked across a computer network. A query engine distributes a desired range of data values to be obtained from the database across a plurality of different query statements. The query statements are simultaneously executed to access the database and transfer associated data subsets into a memory space, after which the data sets are arranged to form the desired range of data values. Preferably, the query engine executes each query statement using a different login account. An auto-brake function is preferably employed to limit input/output (I/O) transfer time for each query statement. Analysis tools perform analysis such as logistic regression and analysis of variance (ANOVA) upon the retrieved data values.

### FIELD OF THE INVENTION

This invention relates generally to the field of computer systems and more particularly, but not by way of limitation, to a method and apparatus for querying a computerized database, such as a distributed database linked over a computer network.

### BACKGROUND

A computerized database is a repository for data from which useful information can be extracted. The database is stored in a memory space and accessed by a query engine to retrieve particular data values of interest. Such databases are typically relational in nature, in that multiple fields of values are arranged to form records that collectively provide attribute and/or parametric data with regard to a particular physical observation or occurrence.

With the continued advent of automated manufacturing processes, databases are increasingly being used to store and track data relating to components and subassemblies that go into manufactured products. In this way, quality management techniques can be employed to control variation within the manufacturing process and drive manufacturing yield improvements. The database can further be employed to identify root causes for testing failures, leading to component and system design improvements that enhance quality and reliability.

Continued advancements in the computer art make it increasingly easier and cost efficient to collect vast amounts of computerized data associated with substantially every aspect of a manufacturing process. Unfortunately, as computer databases become larger and store increasingly greater numbers of records, it becomes significantly more difficult to structure queries that provide meaningful information in a timely manner. The longer it takes to analyze the data and implement appropriate corrective action, the larger the number of manufactured products that continue through the process that are affected by an anomalous failure condition or statistical trend, potentially increasing scrap and rework costs and decreasing product quality and reliability levels.

The delays in obtaining meaningful information are further exasperated by the continued expansion of the global economy; components and subassemblies are often manufactured at different sites, sometimes in different countries, and the components and subassemblies can be shipped to yet another site where the product is assembled and tested. Each of these locations will typically maintain one or more local databases that store various manufacturing and testing data. While these local databases can be treated as a unified distributed database which can be accessed via the Internet or other computer network, moving large amounts of queried data across such networks in a timely fashion remains a daunting task.

There is therefore a continued need for improvements in the art with regard to querying a computerized database in an efficient manner, and it is to such improvements that the present invention is generally directed.

### SUMMARY OF THE INVENTION

In accordance with preferred embodiments, an apparatus and method are provided for querying a computerized database.

The method preferably comprises distributing a desired range of data values to be obtained from the database across a plurality of different query statements. The plurality of query statements is next simultaneously executed to access the database and transfer associated data subsets into a memory space. The data subsets are then arranged to form the desired range of data values.

Preferably, the computerized database comprises a distributed database portions of which are stored in different locations linked by a computer network. The method further preferably comprises exporting the desired range of data values obtained from the arranging step to a second memory space.

An analysis routine is preferably utilized to analyze the desired range of data values in the second memory space. The simultaneously executing step preferably comprises logging into a computer network associated with the database under a different login account for each query statement so that each query statement is simultaneously executed using the associated login account.

The method further preferably comprises initiating an auto-brake function that limits input/output transfer elapsed time by a server associated with the computer network and the database to a maximum value during execution of a selected one of the plurality of query statements.

The apparatus preferably comprises a computer system comprising a database stored in a first memory space and accessible by a computer. A query engine distributes a desired range of data values to be obtained from the database across a plurality of different query statements, simultaneously executes the plurality of query statements to access the database and transfer associated data subsets into a third memory space, and arranges the associated data subsets to form the desired range of data values.

The computer preferably comprises a server computer, and the computer system further comprises a client computer associated with the server computer over a computer network. The client computer executes the query engine to obtain the associated data subsets from the database.

These and various other features and advantages which characterize the claimed invention will be apparent from a reading of the following detailed description and a review of the associated drawings.

### BRIEF DESCRIPTION OF THE DRAWINGS

FIG. 1 is a top plan view of a data storage device constructed and operated in accordance with preferred embodiments of the present invention.

FIG. 2 provides a functional block representation of a manufacturing process and an associated distributed database used to produce the data storage device of FIG. 1.

FIG. 3 is a simplified block diagram of a computer network which employs a query engine constructed and operated in accordance with preferred embodiments of the present invention to access the database of FIG. 2.

FIG. 4 provides a functional representation of a preferred architecture of the query engine.

FIG. 5 is a flow chart for a DATABASE QUERY routine, illustrative of steps carried out by the query engine in accordance with preferred embodiments.

FIG. 6 provides a diagram to illustrate a preferred manner in which the query engine employs separate account logins to execute different query statements to access the database.

FIG. 7 is a graphical representation of elapsed input/output (I/O) time for specific responses obtained during the routine of FIG. 5.

### DETAILED DESCRIPTION

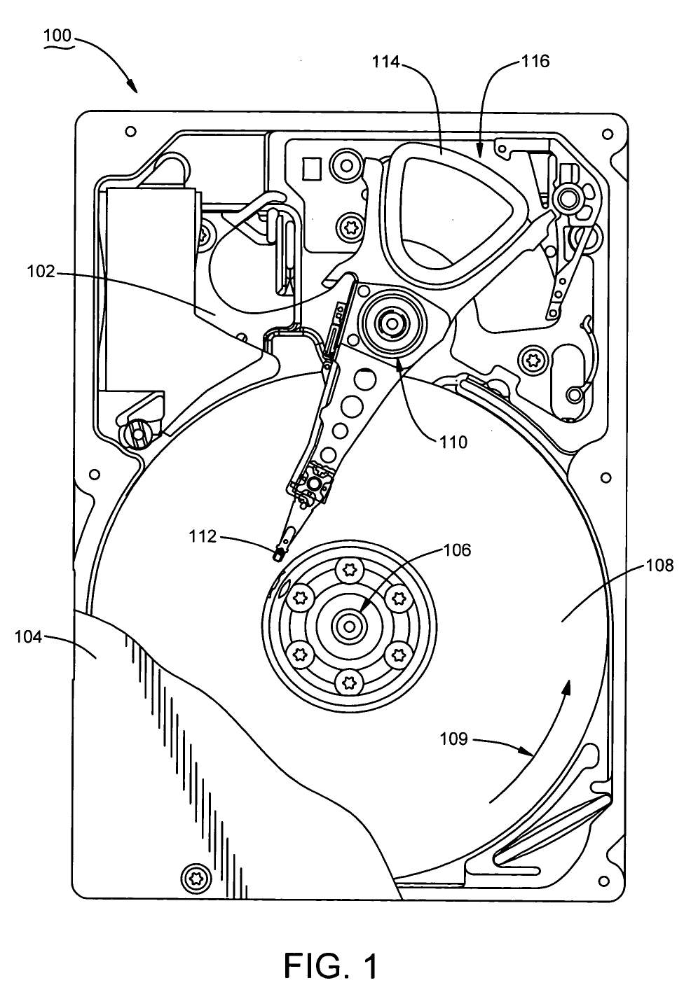

To provide an exemplary environment in which preferred embodiments of the present invention can be advantageously practiced, FIG. 1 shows a disc drive data storage device 100 configured to store and retrieve digital data. A base deck 102 cooperates with a top cover 104 (shown in partial cutaway) to form an environmentally controlled housing for the device 100.

A spindle motor 106 supported within the housing rotates a number of rigid magnetic recording discs 108 in a rotational direction 109. A head/stack assembly, HSA 110 (also referred to as an “actuator”) is provided adjacent the discs 108 and moves a corresponding number of heads 112 across the disc recording surfaces through application of current to an actuator coil 114 of a voice coil motor (VCM) 116. Communication and control electronics for the disc drive 100 are provided on a disc drive printed circuit board assembly (PCBA) mounted to the underside of the base deck 102.

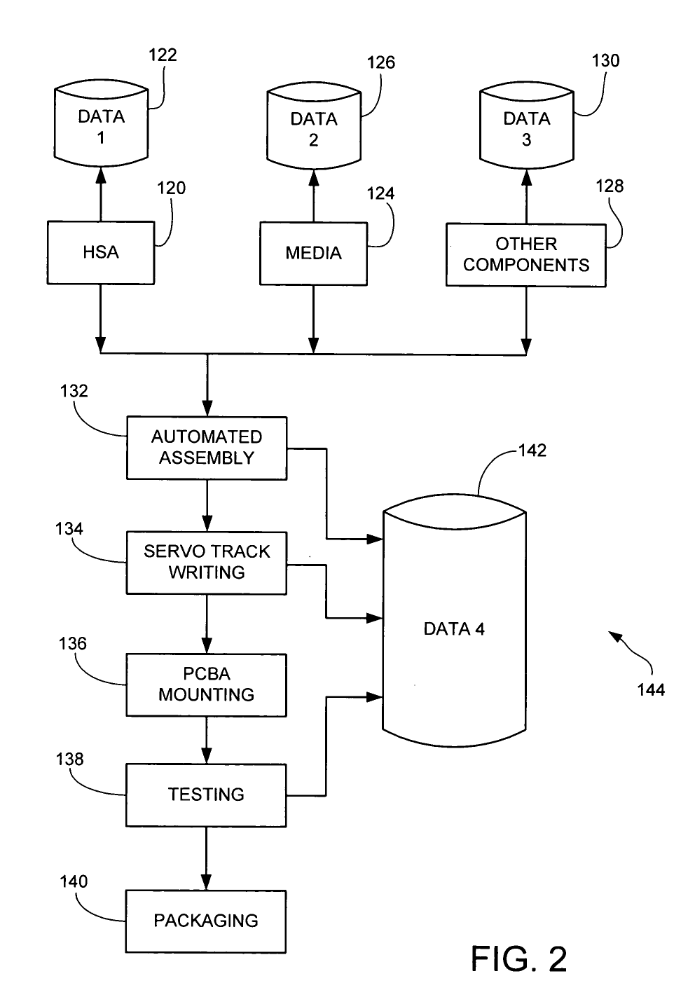

The data storage device 100 is contemplated as having been manufactured in a high volume, automated manufacturing environment such as represented by FIG. 2. In FIG. 2, various components and subassemblies are manufactured and tested by different suppliers at various locations, including different countries.

By way of illustration, block 120 represents an HSA supplier used to supply the HSA 110 in FIG. 1. Those skilled in the art will recognize that the HSA 110 includes a number of complex subassemblies and components, including air-bearing sliders and magneto-resistive (MR) data transducers manufactured using integrated circuit fabrication techniques; head/gimbal assemblies; extruded or stamped and stacked actuator arms, etc. Thus, the block 120 may in turn actually represent a number of different facilities the combined operation of which culminates in the production of the HSAs 110.

An HSA database (DATA 1) is denoted at 122 in FIG. 2 to represent data records collected during the various manufacturing and testing operations performed to complete the HSAs 110. Preferably, a serial number or other unique identifier (such as a date code, etc.) is provided to allow the data in the database 122 to be correlated to individual HSAs 110 at a later date, as necessary.

Block 124 in FIG. 2 represents a media supplier used to supply the media (discs 108) for the data storage devices 100. As before, various fabrication, processing and testing steps are carried out by the media supplier 124, including parametric measurements relating to the magnetic data storage capabilities, laser texturing of landing zones (when employed), the prewriting of servo data for prewritten or patterned discs (when employed), etc. A media database (DATA 2) 126 stores records associated with each disc 108 supplied by the media supplier 124.

Block 128 in FIG. 2 collectively represents a number of additional suppliers for components and subassemblies utilized by the data storage device 100, such as the spindle motor 106, the PCBA, etc. As before, a database (DATA 3) 130 represents the storage of records associated with each of these components and subassemblies.

As shown by FIG. 2, the HSAs 110, discs 108 and other components and subassemblies supplied by the suppliers 120, 124 and 128 are provided to the data storage device manufacturer, which in turn assembles these various components into head/disc assemblies (HDAs) at 132. As those skilled in the art will recognize, an HDA substantially comprises all of the data storage device except for the PCBA. Servo data are written to the discs 108 at servo track writing (STW) operation 134, if such servo data have not already been written to the discs by the media supplier 124.

The PCBAs are affixed to the HDAs at step 136 to provide completed data storage devices 100, and the completed devices are configured and tested at step 138. This testing typically includes extended burn-in testing in environmental chambers to identify and weed out early life failures. Devices 100 that successfully complete the testing step 138 are packaged at 140 and shipped, while devices that fail during testing are analyzed and either reworked or scrapped.

An assembly process database (DATA 4) is represented at step 142 in FIG. 2. This database 142 collects data obtained during processing steps 132 (assembly), 134 (servo track writing) and 138 (testing). The various local databases 122, 126, 130 and 142 collectively make up a distributed database 144 that is accessible over a computer network such as the Internet.

While various “local” statistical and other process control techniques are employed at the various processing steps, “global” process control techniques are also employed. One important global process parameter is manufacturing yield, which represents the percentage of the devices 100 that successfully complete the testing step 138. As will be recognized, a higher yield is generally desirable (assuming all latent defects are previously found and eliminated) as this makes more devices available for shipment and, hence, the collection of revenue. Tracking process yield, and other global parameters, can therefore be an important aspect in the control of the process of FIG. 2.

As will be recognized, when statistically significant variations in global parameters are observed, it is generally desirable to initiate an investigation to identify the cause(s) associated with this variation. This allows corrective measures to be implemented “upstream” in the process to eliminate such variations in the future.

Such investigations often require timely analysis of the data in the database 144. Unfortunately, due to the size and distributed nature of the database 144, rapid access to the data is often difficult to obtain. This can further be complicated by organizational limitations (e.g., the time required for requests to be made to different IT groups at different sites responsible for the various local databases, etc.) and technical limitations (e.g., nonstandardized formats for raw data, the requirement for manual sorting of retrieved data, etc.). Thus, conventional data collection and analysis methodologies do not support real time response, provide reduced accuracy, allow for the inconsistent interpretation of data, and have a high operating cost.

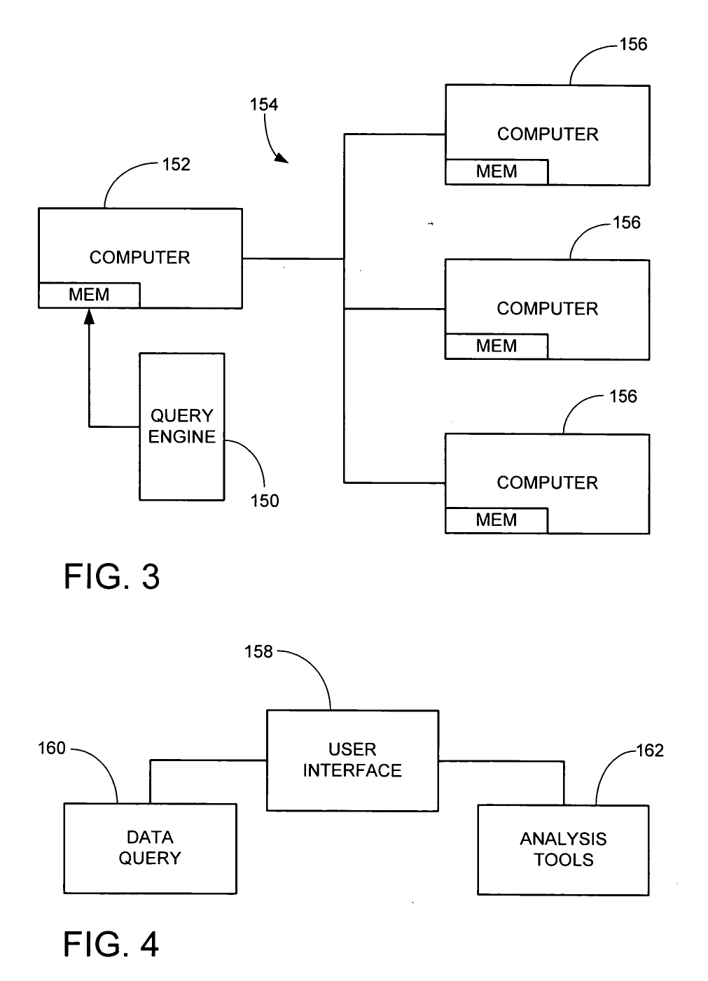

Accordingly, as represented in FIG. 3, a query engine 150 is provided in accordance with preferred embodiments of the present invention to allow the timely and efficient querying of a database such as 144. The query engine 150 is resident in a local computer 152 and communicates over a computer network 154 to various remote computers 156 to access the database 144. A generalized architecture for the query engine is provided in FIG. 4.

The query engine 150 is preferably written in a suitable SQL compatible programming language. The engine 150 includes a Windows® based graphical user interface (GUI) block 158 that provides the user with easy access to the data in selectable functional groups, as well as analysis tools to perform data analysis tasks on the retrieved data.

As discussed below, a data query block 160 formulates appropriate query statements to be directed to the various databases. An analysis tool block 162 controls the use of a debug analyzer routine, a tester analyzer routine, a trend analyzer routine, etc. to analyze attribute data (source, lot number, PASS/FAIL, etc.) and parametric data (continuous variables relating to measurements, etc.) using logistic regression and ANOVA (analysis of variance) techniques as required.

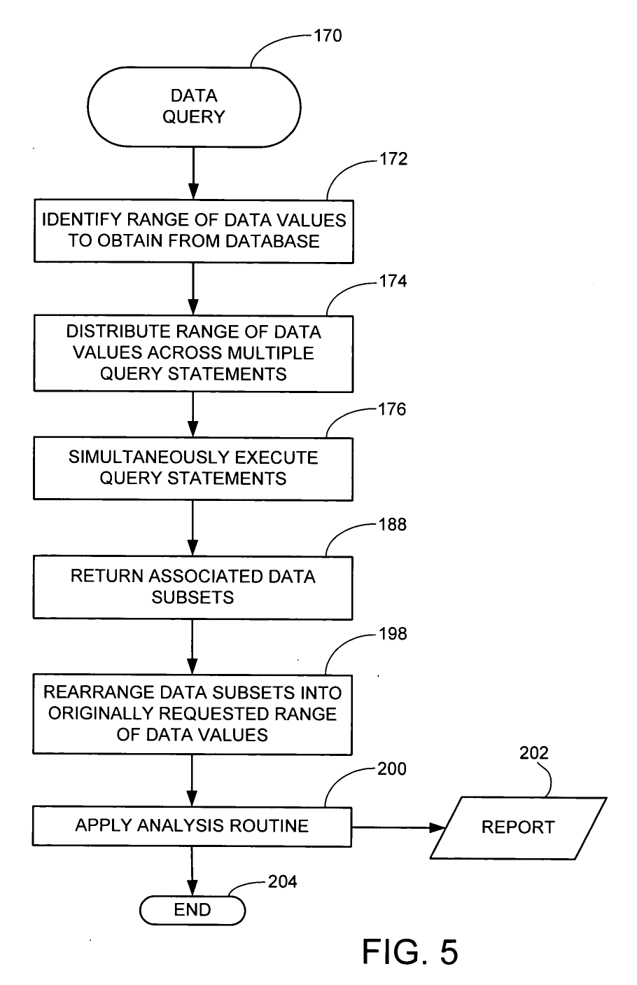

FIG. 5 provides a flow chart for a DATABASE QUERY routine 170, representative of steps carried out by the query engine 150 in accordance with preferred embodiments to access the database 144.

At step 172, the desired range of data values is first identified by the user. While this range will be highly dependent upon the structure and contents of the database as well as the particular circumstances associated with the query, this range can be generally understood as simply corresponding to the desired data to be pulled.

For example, the desired range of data values can comprise all records from all locations relating to a particular one or a number of devices 100; selected records relating to media (or some other component) processed within a given time frame; all data associated with a particular production date, etc. The GUI block 158 (FIG. 4) is preferably configured to allow the user to readily identify this desired range of data values.

At step 174, this desired range of data values is distributed across multiple query statements. The query statements are formulated by the query block 154 using appropriate rules suited to provide efficient access to the database 144. For example, the query statements can be advantageously arranged so that a different query statement accesses the desired data records from each one of the different local databases (e.g., 122, 126, 130, 142).

For relatively high volume queries, the query statements can further be arranged to request the same types of records from the same database (e.g., one query statement can request the first 1000 records, another query statement can request the next 1000 records, etc.). The format for each query statement will of course depend upon the construct of the database, but will preferably be SQL based and provide the returned data in a *.CSV file format.

Once the query statements have been formulated, the routine of FIG. 5 proceeds to step 176 where the query statements are simultaneously executed. For clarity, the term “simultaneously executed” does not mean that all of the data transfer requests associated with the various query statements are commenced (initiated) at exactly the same time, but rather describes the fact that all of the query statements are serviced (executed) simultaneously; that is, the statements will take some amount of elapsed time to complete, and during this time all of the query statements are being serviced and data are being retrieved therefor. This is in contrast to a “sequential” approach wherein the first query statement is completed, after which the next query statement is completed, and so on.

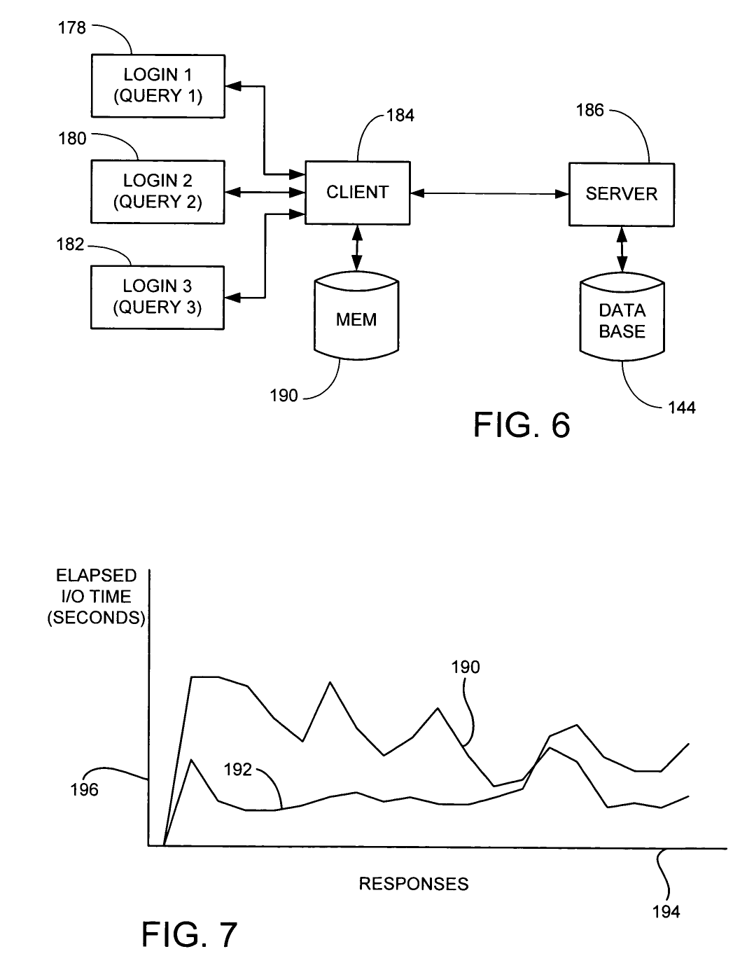

Breaking up the data range into appropriate query statements which are simultaneously executed can significantly reduce the elapsed time required to complete the data pull as compared to prior art solutions. A preferred manner in which the step 176 is carried out is by the separate logging in to the computer network 154 under different user accounts (IDs), and executing each query statement under a different account. This is represented in FIG. 6.

FIG. 6 shows three different login accounts 178, 180 and 182 that are opened by the query engine 160 for three associated query statements. Each account is associated with a client computer 184 in which the query engine 150 is resident (although the queries can be initiated from separate client computers as desired).

An advantage of this approach is that a server computer 186 associated with processing multiple query statements will treat each query as coming from a different user, and thus will apply native distribution rules to further balance the efficient servicing of the query statements. Another advantage is that the query statements can be serviced along with other operational loads upon the system from other users (such as, for example, the updating of the database 144 during ongoing production processing).

Returning to FIG. 5, step 188 represents the return of data subsets associated with each of the query statements to a memory space (such as memory 190 in FIG. 6) during the execution of step 176. Another preferred feature of the query engine 150 is an auto-brake function, which serves to limit input/output (I/O) transfer elapsed time by the server 186 to a maximum value during execution of a selected one of the plurality of query statements. The auto-brake function establishes a maximum time (such as 30 seconds) during which records can be pulled for a given query statement before the server 186 interrupts that particular transfer and moves on to another query. This prevents the server from “bogging down” by concentrating on one particular transaction for too long to the exclusion of the other ongoing query statement executions.

FIG. 7 provides a graphical representation to show efficiencies gained using the auto-brake function. FIG. 7 shows first and second data pull curves 190, 192 plotted against an x-axis 194 indicative of the number of sequential responses (transactions) during which subsets of the data are pulled into the memory 190. A y-axis 196 indicates elapsed I/O time (in seconds).

The first curve 190 generally represents a data pull without the use of the auto-brake function, whereas the second curve 192 generally represents a data pull with the use of the auto-brake function. Both curves 190, 192 resulted in substantially the same total number of data records pulled (e.g., on the order of 13,000 total records each), but the curve 190 required about 25% more total elapsed time as compared to the curve 192.

Those skilled in the art will recognize that it is generally true that the longer a particular I/O transaction is maintained, the higher the number of records that can be pulled during the transaction. However, it is also often observed that the longer a particular I/O transaction link is maintained, the higher the probability that some sort of anomalous event will cause a bogging down, delay, server lockup, or other condition that adversely affects the efficient transfer of data.

Hence, by limiting the maximum amount of time that the server 186 is allowed to satisfy a particular query statement (such as represented by curve 192), server timeouts are reduced and more efficient data transfers can occur. It will be noted that the auto-brake function is preferably available for user selection via the GUI 152 (FIG. 3), including the ability of the user to specify the value of the auto-brake cut-off limit.

Once all of the requested data subsets have been obtained, the flow of FIG. 5 continues to step 198 where the various subsets of data are rearranged into the desired range of data values identified during step 172, allowing subsequent analysis of the data at step 200.

The analysis step 200 is preferably carried out using the analysis tools block 162 and can include the transfer of the retrieved data to another memory space suitable for such operation. As mentioned above, any number of conventional analysis techniques can be applied, including statistical process control, regression, ANOVA, etc. Reports such as represented at 202 are generated allowing responsible manufacturing personnel to reach accurate conclusions and implement appropriate corrective actions, as required. The process then ends at step 204.

It will be noted that the query engine 150 provides several advantages, including lower setup and maintenance costs, unified and coherent data acquisition and trend analysis, higher speed, and improved data integrity. Undesired data records are not pulled, and no time consuming sorting or manual filtering of the data is required.

Another advantage is the ability of the query engine 150 to operate on an automated basis; that is, data requests can be tailored and executed daily to operate “in the background” of the network. Using this approach, it has been found that 80%-90% of the desired data will have already been pulled and provided to the client computer for localized sorting and analysis, further reducing the delays associated with data acquisition when a particular query is needed.

While the query engine 150 is particularly suited for a high volume data storage device automated manufacturing environment, it will be clear that the present invention is not so limited. Rather, any number of applications where real time data querying is desired can employ the query engine to carry out such queries in an efficient manner.

It will now be understood that the present invention, as embodied herein and as claimed below, is generally directed to a method and apparatus for querying a computerized database. In accordance with preferred embodiments, the method generally includes distributing a desired range of data values to be obtained from the database across a plurality of different query statements (such as by step 174); simultaneously executing the plurality of query statements to access said database and transfer associated data subsets into a memory space (such as by step 176); and arranging the associated data subsets to form the desired range of data values (such as by step 198).

Preferably, the computerized database comprises a distributed database (such as 144) portions of which (such as 122, 126, 130, 142) are stored in different locations linked by a computer network (such as 154). The method further preferably comprises exporting the desired range of data values obtained from the arranging step to a second memory space (such as by step 200).

An analysis routine (such as 162) is preferably utilized to analyze the desired range of data values in the second memory space. The simultaneously executing step preferably comprises logging into a computer network associated with the database under a different login account for each query statement (such as 178, 180, 182) so that each query statement is simultaneously executed using the associated login account.

The method further preferably comprises initiating an auto-brake function (such as represented by 192) that limits input/output transfer elapsed time by a server associated with the computer network and the database to a maximum value during execution of a selected one of the plurality of query statements.

The apparatus preferably comprises a computer system comprising a database (such as 144) stored in a first memory space and accessible by a computer (such as 156, 186); and a query engine (such as 150) stored in a second memory space which, upon execution, distributes a desired range of data values to be obtained from the database across a plurality of different query statements, simultaneously executes the plurality of query statements to access the database and transfer associated data subsets into a third memory space, and arranges the associated data subsets to form the desired range of data values.

The computer preferably comprises a server computer (such as 156, 186), wherein the computer system further comprises a client computer (such as 152, 184) associated with the server computer over a computer network (such as 154), and wherein the client computer executes the query engine.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

1. A method for querying a computerized database, comprising:
distributing a desired range of data values to be obtained from the database across a plurality of different query statements;
simultaneously executing the plurality of query statements to access said database and transfer associated data subsets into a memory space; and
arranging the associated data subsets to form the desired range of data values.

2. The method of claim 1, wherein the computerized database comprises a distributed database portions of which are stored in different locations linked by a computer network.

3. The method of claim 1, further comprising exporting the desired range of data values obtained from the arranging step to a second memory space.

4. The method of claim 1, further comprising using an analysis routine to analyze the desired range of data values.

5. The method of claim 1, wherein at least one query statement retrieves data values from the database for a selected data field type, and wherein at least one other query statement retrieves data values from the data base for the selected data field type.

6. The method of claim 1, wherein the desired range of data values comprises manufacturing data associated with manufacture of a population of products.

7. The method of claim 6, wherein the products comprise data storage devices.

8. The method of claim 1, wherein the simultaneously executing step comprises logging into a computer network associated with the database under a different login account for each query statement so that each query statement is simultaneously executed using the associated login account.

9. The method of claim 8, wherein the simultaneously executing step further comprises initiating an auto-brake function that limits input/output transfer elapsed time by a server associated with the computer network and the database to a maximum value during execution of a selected one of the plurality of query statements.

10. The method of claim 1, wherein the distributing, simultaneously executing and arranging steps are carried out on a repetitive, daily basis to obtain data relating to an ongoing manufacturing process.

11. A computer system, comprising:
a database stored in a first memory space and accessible by a computer; and
a query engine stored in a second memory space which, upon execution, distributes a desired range of data values to be obtained from the database across a plurality of different query statements, simultaneously executes the plurality of query statements to access the database and transfer associated data subsets into a third memory space, and arranges the associated data subsets to form the desired range of data values.

12. The computer system of claim 11, wherein the computer comprises a server computer, wherein the computer system further comprises a client computer associated with the server computer over a computer network, and wherein the client computer executes the query engine.

13. The computer system of claim 11, wherein the database comprises a distributed database so that the memory space comprises a plurality of different locations linked by a computer network.

14. The computer system of claim 11, wherein the query engine subsequently exports the desired range of data values to a fourth memory space.

15. The computer system of claim 11, further comprising an analysis routine which analyzes the desired range of data values.

16. The computer system of claim 11, wherein the desired range of data values comprises manufacturing data associated with manufacture of a population of products.

17. The computer system of claim 16, wherein the products comprise data storage devices.

18. The computer system of claim 11, wherein the simultaneously executing step comprises logging into a computer network associated with the database under a different login account for each query statement so that each query statement is simultaneously executed using the associated login account.

19. The computer system of claim 18, wherein the simultaneously executing step further comprises initiating an auto-brake function that limits input/output transfer elapsed time by a server associated with the computer network and the database to a maximum value during execution of a selected one of the plurality of query statements.

20. The method of claim 1, wherein the query engine extracts the desired range of data values on a repetitive, daily basis to obtain data relating to an ongoing manufacturing process.
